(19) United States
(12) Patent Application Publication
(10) Pub. No.: US 2014/0130990 A1
(43) Pub. Date: May 15, 2014

(54) RETRACTABLE SHADE

(71) Applicant: Tai Chow Wong, North Point (HK)

(72) Inventor: Tai Chow Wong, North Point (HK)

(73) Assignee: ROLLAWORLD LLC, Los Angeles, CA (US)

(21) Appl. No.: 14/078,937

(22) Filed: Nov. 13, 2013

Related U.S. Application Data
(60) Provisional application No. 61/726,051, filed on Nov. 14, 2012.

(51) Int. Cl. B60J 1/00; B32B 37/12; B32B 38/00; E06B 9/42

(52) U.S. Cl. CPC B60J 1/00; E06B 9/42; B32B 37/12; B32B 38/145
USPC 160/309; 156/277

(57) ABSTRACT

Herein is provided a self-rolling sunshade that includes a self-rolling sheet which has a first polyethylene terephthalate (PET) film that carries an image layer, has a thickness in a range of about 25 μm to about 50 μm, preferably about 30 μm to about 45 μm, more preferably about 35 μm to about 40 μm, even more preferably about 38 μm, and has an elastic state selected from a stretched state and a relaxed state. The self-rolling sheet further includes the image layer disposed between the first PET film and an aluminized PET film and including a photostable ink, preferably a UV absorbing ink. The aluminized PET film has a thickness in a range of about 5 μm to about 25 μm, preferably about 10 μm to about 20 μm, more preferably about 15 μm, and less than the thickness of the first PET film; comprises a second PET film and an aluminum layer; and has an elastic state selected from a stretched state and a relaxed state, wherein the elastic state of the aluminized PET is not the same as the elastic state of the first PET film.

### CROSS-REFERENCE TO RELATED APPLICATIONS

This disclosure claims the benefit of priority to U.S. Provisional Patent Application No. 61/726,051 filed 14 Nov., 2012, the disclosure of which is incorporated herein in its entirety.

### FIELD OF THE INVENTION

The present invention relates to self-rolling or self-winding sheet materials, particularly self-rolling sunshades adapted for attachment to or across a window.

### BACKGROUND

As described in U.S. Pat. No. 4,202,396, the state of the art of sunshades for motorcars before said patent generally fell into two main categories: Outdoor and indoor. The outdoor devices were comprised of an acute semi-transparent member mounted above the upper portion of the front window. These devices filter and shade part of the interior of a car only when the sun is at the higher part of its orbit.

The indoor means were either curtains or venetian blinds that were permanently affixed to the side or rear window frames. Alternatively, for the protection of front window, plain flat sheets of any rigid material were used, which were dimensioned that they could be placed on the dashboard cover.

U.S. Pat. No. 4,202,396 changed the state of the art by providing a foldable sunblind for motor-car windows characterized by a self-contained unit adapted to assume either a stretched position, forming a substantially continuous partition detachably mountable at the inner side of said windows, or a collapsed position, forming box-like package. The unit comprised a series of planar rectangular board elements folded jointed to each other along their longitudinal edges. At least two flaps were integrally provided with two space elements adapting the said partitions to be appended from a fitting of the motorcar.

These sunshades are today by far the most popular and widely sold of the various types now on the market. However, they suffer from several major disadvantages. For example, the folding and unfolding process is tedious due to the fact that the sunshade with its rigid joined panels is cumbersome since each panel measures about 60 cm×13 cm and each shade contains about ten such panels. Additionally, even in its folded state this sunshade occupies substantial space on the floor of a car when not in use and is constantly getting underfoot and in the way. Moreover, the folded blind is to be held together by a rubber-band which is frequently and easily lost.

For several years there has also been available on the market a sunblind formed of a sheet of thin rollable plastic laminated with a thin sheet of aluminum foil and provided at its ends with means for attachment across a car window surface. While such a shade is more compact in its rolled state than the box-like package of joined rectangular panels, the rolling and unrolling thereof is also time-consuming and annoying.

With this state of the art in mind and especially in light of the widespread need for sunshades which would protect the interiors of motor vehicles from the sun's heat and harmful bleaching rays and the aforementioned dissatisfaction with the disadvantages of the presently marketed products, there is now provided a new type of sunblind which ameliorates the above problems and provides a much more convenient and easy-to-use and store sunblind than those that have been heretofore available.

### SUMMARY

A first embodiment is a self-rolling sunshade that includes a self-rolling sheet which has a first polyethylene terephthalate (PET) film that carries an image layer, has a thickness in a range of about 25 μm to about 50 μm, preferably about 30 μm to about 45 μm, more preferably about 35 μm to about 40 μm, even more preferably about 38 μm, and has an elastic state selected from a stretched state and a relaxed state. The self-rolling sheet further includes the image layer disposed between the first PET film and an aluminized PET film and including a photostable ink, preferably a UV absorbing ink. The aluminized PET film has a thickness in a range of about 5 μm to about 25 μm, preferably about 10 μm to about 20 μm, more preferably about 15 μm, and less than the thickness of the first PET film. The aluminized PET film includes a second PET film and an aluminum layer; and has an elastic state selected from a stretched state and a relaxed state, wherein the elastic state of the aluminized PET is not the same as the elastic state of the first PET film.

Another embodiment is a process for manufacturing a self-rolling sunshade. The process includes preparing a self-rolling sheet that includes providing a first polyethylene terephthalate (PET) film having a thickness in a range of about 25 μm to about 50 μm, preferably about 30 μm to about 45 μm, more preferably about 35 μm to about 40 μm, even more preferably about 38 μm. Printing an image layer upon a side of the first PET film and curing the image layer. Then providing an aluminized PET film having a thickness in a range of about 5 μm to about 25 μm, preferably about 10 μm to about 20 μm, more preferably about 15 μm, and less than the thickness of the first PET film and comprising a second PET film and an aluminum layer. Adhesively bonding the aluminized PET film to the side of the first PET film carrying the cured image layer; thereby disposing the image layer between the first PET film and the aluminized PET film; and then curing the adhesively bonded films.

### BRIEF DESCRIPTION OF THE FIGURES

For a more complete understanding of the disclosure, reference should be made to the following detailed description and accompanying drawing figures wherein:

FIG. 1 is a schematic representation of the herein described self-rolling sheet;

FIG. 2 is a schematic perspective view of a self-rolling sunshade; in its unrolled state; and

FIG. 3 is a cross-sectional view of FIG. 2.

While specific embodiments are illustrated in the figures, with the understanding that the disclosure is intended to be illustrative, these embodiments are not intended to limit the invention described and illustrated herein.

### DETAILED DESCRIPTION

A first embodiment is a self-rolling sunshade that includes a self-rolling sheet. Herein, self-rolling means the sheet in an unfurled or unrolled state will upon the removal of the forces holding the sheet and without the application of external forces roll or twist into a cylindrical form. The self-rolling sheet includes a first polyethylene terephthalate (PET) film that can have a thickness in a range of about 25 μm to about 50 μm, preferably about 30 μm to about 45 μm, more preferably about 35 μm to about 40 μm, even more preferably about 38 μm.

The first PET film has an elastic state selected from a stretched state and a relaxed state. That is, the first PET film in the self-rolling sheet is either in a stretched state (e.g., applying an internal force to the sheet sufficient to cause an unfurled sheet to roll into a cylindrical form) or a relaxed state (e.g., not applying internal forces to the sheet sufficient to cause an unfurled sheet to roll into a cylindrical form).

Importantly, the first PET film carries an image layer. The image layer preferably includes photostable ink or inks, that is, inks that do not fade due to prolonged exposure to solar radiation. More preferably the image layer includes UV absorbing ink or inks, even more preferably the image layer includes sufficient quantity of UV absorbing ink to provide a UV transmission of less than 10%, less than 5%, or less than 1%. Preferably, the image layer is disposed between the first PET film and an aluminized PET film. That is, the image layer is internal to the self-rolling sheet.

The self-rolling sheet additionally includes an aluminized PET film. The aluminized PET film can have a thickness in a range of about 5 μm to about 25 μm, preferably about 10 μm to about 20 μm, or more preferably about 15 μm. Furthermore, the aluminized PET film preferably has a thickness that is less than the thickness of the first PET film, more preferably the aluminized PET film thickness is less than half the first PET film thickness.

The aluminized PET film includes a second PET film and an aluminum layer. Preferably, the aluminum layer has a thickness of less than 1 μm, more preferably less than 0.5 μm. In one preferable example, the aluminized PET film comprises a vapor deposited aluminum layer carried by the second PET film. The vapor deposited aluminum layer can be formed by, for example, physical vapor deposition or chemical vapor deposition. Notably, the thickness of the vapor deposited aluminum layer can be about 10 nm, 25 nm, 50 nm, 75 nm, 100 nm, 125 nm, 150 nm, 200 nm, 300 nm, 400 nm, or 500 nm. In an example, the aluminized PET layer includes a sufficiently thick aluminum layer to prevent greater than 90%, greater than 95%, or greater than 99% of visible light transmission through the aluminized PET layer. In another example, the aluminized PET layer includes a sufficiently thin aluminum layer to allow a visible light transmission of about 10%, 15%, 20%, 25%, 50%, or 75%.

Furthermore, the aluminized PET film has an elastic state selected from a stretched state and a relaxed state. That is, the aluminized PET film in the self-rolling sheet is either in a stretched state (e.g., applying an internal force to the sheet sufficient to cause an unfurled sheet to roll into a cylindrical form) or a relaxed state (e.g., not applying internal forces to the sheet sufficient to cause an unfurled sheet to roll into a cylindrical form). Notably, the elastic state of the aluminized PET is not the same as the elastic state of the first PET film (e.g., when the first PET film is in a relaxed state, the aluminized PET film is in a stretched state).

The self-rolling sunshade can additionally include an adhesive layer disposed between the first PET film and the aluminized PET film. The adhesive layer preferably has a thickness of less than 50 μm, 25 μm, or 5 μm. The adhesive layer can include a thermoplastic adhesive and/or a pressure-sensitive adhesive. Preferably, the adhesive layer is selected from the group consisting of polyacrylates, polycyanoacrylates, polyurethanes, polyacetates, polyesters, polyols, bioadhesives, epoxy resins, and mixtures thereof. More preferably, the adhesive layer includes a polyurethane. In one preferable example, the polyurethane is carried in a volatile organic solvent, for example, ethyl acetate, diethyl ether, acetone, methyl acetate, butyl acetate, methyl ethyl ketone, butyl ethyl ether, and the like.

Preferably, the self-rolling sunshade has the aluminum layer disposed between the first PET film and the second PET film. That is, the aluminum layer is, preferably, disposed within the self-rolling sheet. The aluminum layer is further preferably disposed adjacent to the adhesive layer. In one example, the first PET film can carry the adhesive layer; the adhesive layer carried the aluminum layer; and the aluminum layer carries the second PET film.

In another example, the self-rolling sunshade includes a plurality of self-rolling sheets. Individually, the self-rolling sheets include a first major surface that is carried by the first PET film and a second major surface that is carried by the aluminized PET film. These self-rolling sheets are preferably adhered such that the first major surface of a first self-rolling sheet is adhered to the second major surface of a second self-rolling sheet. That is, each pair of expanded self-rolling sheets will roll in opposite directions (e.g., clock-wise and counter-clock-wise). In one preferable example, the self-rolling sunshade includes only two self-rolling sheets; notably, the self-rolling sunshade can further include hardware (e.g., window mounting hardware).

Another embodiment is a process for manufacturing a self-rolling sunshade. The process can include preparing a self-rolling sheet. The preparation of the self-rolling sheet can include providing a first polyethylene terephthalate (PET) film that has a thickness in a range of about 25 μm to about 50 μm, preferably about 30 μm to about 45 μm, more preferably about 35 μm to about 40 μm, even more preferably about 38 μm. The process can then include printing an image layer upon a side of the first PET film and curing the image layer. The image can be provided by printing, laminating, or otherwise depositing an image (e.g., an ink layer) upon the PET film. One preferable method of providing the image is the application of an ink layer by a rotogravure printing machine. The curing of the image can include heating the PET film carrying the image and/or maintaining the PET film at a temperature for an extended period of time. In one preferable example the provided image on the PET film is cured at room temperature for about 12, 24, 36, 48, or 60 hours, more preferable the image is cured for about 48 hours.

The process can then include providing an aluminized PET film that has a thickness in a range of about 5 μm to about 25 μm, preferably about 10 μm to about 20 μm, more preferably about 15 μm, and where the thickness is less than the thickness of the first PET film. The aluminized PET film preferably includes a second PET film and an aluminum layer. The process of preparing the self-rolling sheet can then include adhesively bonding the aluminized PET film to the side of the first PET film carrying the cured image layer; thereby disposing the image layer between the first PET film and the aluminized PET film. Notably, the adhesive bond can be formed by providing an adhesive and the adhesive can be provided/applied to the aluminized PET film, to the first PET film, or to both films simultaneously. After applying the adhesive and adhesively bonding the films, the process includes curing the adhesively bonded films.

As noted previously, an important aspect of the present invention is the difference in the stretched/relaxed states between the first PET film and the aluminized PET film. These differences can be provided during the preparation of the self-rolling film. In one example, the aluminized PET film is heat shrunk after it is adhesively bonded to the first PET film. This process can include heat shrinking the aluminized PET film after adhesively bonding to the first PET film and then curing the adhesively bonded films. Alternatively, the process can include heat shrinking the aluminized PET film after adhesively bonding to the first PET film after the curing of the adhesively bonded films. In another example, the process can include providing the aluminized PET film in a stretched elastic state and adhesively bonding the stretched aluminized PET film to the first PET film. In this example, the first PET film is preferably in a relaxed state. The adhesively bonded films can then be cured in either a rolled state or in an unrolled (e.g., flat) state.

Still further, the process can include preparing a plurality of self-rolling sheets; each sheet having a first major surface that is carried by the first PET film and a second major surface that is carried by the aluminized PET film; and then bonding at least two self-rolling sheets wherein the first major surface of a first self-rolling sheet is adhered to the second major surface of a second self-rolling sheet.

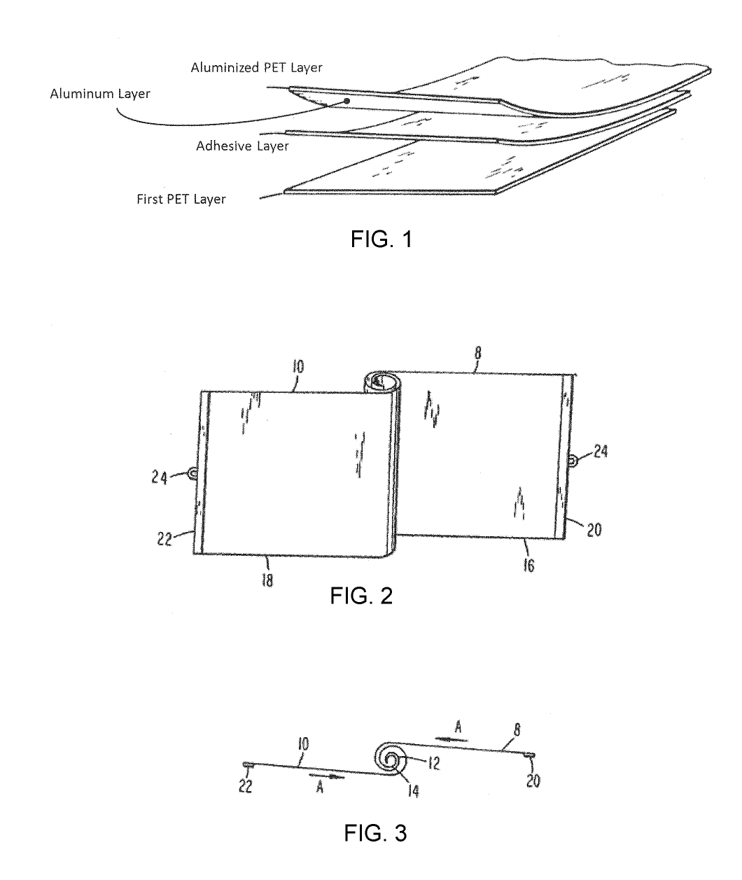

Regarding the figures, in FIG. 1 there is schematically shown a portion of a self-rolling sheet according to the present invention in its tensioned unrolled configuration. In FIGS. 2 and 3 there is schematically shown a preferred embodiment of the present invention in which two self-rolling sheets 8, 10 according to the present invention are joined together by the welding of one edge 12 of a first sheet 8 to an aligned edge 14 of the second sheet 10. This welding is attained in an arrangement whereby due to the internal tension of each sheet they will concentrically roll around each other, with said joined edges 12 and 14 serving substantially as the axis around which said blind rolls up in its relaxed state.

The two unjoined ends 16, 18 of said sheets can be attached to a PVC rigidifying strip 20, 22 provided with apertures 24 attachable to hooks (not shown) affixed to both ends of the window to be covered. The thus prepared self-rolling sunshade, when released, spontaneously rolls up upon itself in the direction of arrows A as a result of the different states of stretching of the pretensioned sheets of the present invention.

It will be realized that instead of joining edges 12 and of two separate sheets 8 and 10 as shown, the same effect can be achieved by using a press to form a permanent fold line in a single sheet at the area where edges 12 and 14 are shown as joined in FIG. 3.

What is claimed:

1. A self-rolling sunshade comprising: a self-rolling sheet that comprises
a first polyethylene terephthalate (PET) film
carrying an image layer, having a thickness in a range of about 25 μm to about 50 μm, and having an elastic state selected from a stretched state and a relaxed state;
the image layer disposed between the first PET film and an aluminized PET film,
comprising a photostable ink; and
the aluminized PET film
having a thickness in a range of about 5 μm to about 25 μm, and less than the thickness of the first PET film;
comprising a second PET film and an aluminum layer; and
having an elastic state selected from a stretched state and a relaxed state, wherein the elastic state of the aluminized PET is not the same as the elastic state of the first PET film.

2. The self-rolling sunshade of claim 1 further comprising an adhesive layer disposed between the first PET film and the aluminized PET film, the adhesive layer comprising a polyurethane.

3. The self-rolling sunshade of claim 1, wherein the aluminum layer is disposed between the first PET film and the second PET film and is adjacent to the adhesive layer.

4. The self-rolling sunshade of claim 1, wherein the aluminized PET film comprises a vapor deposited aluminum layer carried by the second PET film.

5. The self-rolling sunshade of claim 1, wherein the first PET film has a thickness in a range of about 35 μm to about 40 μm and wherein the aluminized PET film has a thickness in a range of about 10 μm to about 20 μm.

6. The self-rolling sunshade of claim 1, wherein the photostable ink is a UV absorbing ink

7. The self-rolling sunshade of claim 1 further comprising a plurality of self-rolling sheets; wherein each sheet comprises a first major surface that is carried by the first PET film and a second major surface that is carried by the aluminized PET film; wherein the first major surface of a first self-rolling sheet is adhered to the second major surface of a second self-rolling sheet.

8. The self-rolling sunshade of claim 1 further comprising a means for attachment of ends of the self-rolling sheet across a window surface wherein upon release of at least one of the ends of the self-rolling sheet, the self-rolling sheet will spontaneously rollup upon itself as a result of different states of stretch of first PET layer and the aluminized layer.

9. A process for manufacturing a self-rolling sunshade comprising:
preparing a self-rolling sheet that comprises
providing a first polyethylene terephthalate (PET) film having a thickness in a range of about 25 μm to about 50 μm,
printing an image layer upon a side of the first PET film;
curing the image layer;
providing an aluminized PET film having a thickness in a range of about 5 μm to about 25 μm, and less than the thickness of the first PET film and comprising a second PET film and an aluminum layer;
adhesively bonding the aluminized PET film to the side of the first PET film carrying the cured image layer; thereby disposing the image layer between the first PET film and the aluminized PET film; and
curing the adhesively bonded films.

10. The process of claim 9 further comprising heat shrinking the aluminized PET film after adhesively bonding to the first PET film and then curing the adhesively bonded films.

11. The process of claim 9 further comprising providing the aluminized PET film in a stretched elastic state and adhesively bonding the stretched aluminized PET film to the first PET film.

12. The process of claim 11, wherein the first PET film is in a relaxed state.

13. The process of claim 9 further comprising preparing a plurality of self-rolling sheets; wherein each sheet comprises a first major surface that is carried by the first PET film and a second major surface that is carried by the aluminized PET film; and then bonding at least two self-rolling sheets, wherein the first major surface of a first self-rolling sheet is adhered to the second major surface of a second self-rolling sheet.

14. A process for manufacturing a self-rolling sunshade comprising:
preparing a self-rolling sheet that comprises
providing a first polyethylene terephthalate (PET) film having a thickness in a range of about 25 μm to about 50 μm,
printing an image layer upon a side of the first PET film;
curing the image layer;
aluminizing the image layer thereby providing an aluminum layer carried by the image layer;
adhesively bonding a second PET film, having a thickness in a range of about 5 μm to about 25 μm, and less than the thickness of the first PET film, to the first PET film; thereby disposing the image layer and aluminum layer between the first PET film and the second PET film; and
curing the adhesively bonded films.

15. The process of claim 14 further comprising heat shrinking the second PET film after adhesively bonding to the first PET film, then curing the adhesively bonded films.

16. The process of claim 14 further comprising providing the second PET film in a stretched elastic state and adhesively bonding the stretched second PET film to the first PET film.

17. The process of claim 16, wherein the first PET film is in a relaxed state.

18. The process of claim 14 further comprising preparing a plurality of self-rolling sheets; wherein each sheet comprises a first major surface that is carried by the first PET film and a second major surface that is carried by the second PET film; and then bonding at least two self-rolling sheets, wherein the first major surface of a first self-rolling sheet is adhered to the second major surface of a second self-rolling sheet.
